(19) United States
(12) Patent Application Publication
(10) Pub. No.: US 2022/0292795 A1
(43) Pub. Date: Sep. 15, 2022

(54) FACE IMAGE PROCESSING METHOD, ELECTRONIC DEVICE, AND STORAGE MEDIUM

(71) Applicant: Beijing Baidu Netcom Science and Technology Co., LTD., Beijing (CN)

(72) Inventor: Ruizhi CHEN, BEIJING (CN)

(21) Appl. No.: 17/827,403

(22) Filed: May 27, 2022

(30) Foreign Application Priority Data
Jul. 14, 2021 (CN) 202110796598.X

(51) Int. Cl. G06T 19/20; G06T 17/20; G06T 7/149; G06T 7/70; G06T 7/11

(52) U.S. Cl. CPC G06T 19/20; G06T 17/20; G06T 7/149; G06T 7/70; G06T 7/11; G06T 2219/2024; G06T 2207/30201; G06T 2207/20021; G06T 2200/08

(57) ABSTRACT

A face image processing method, an electronic device and a storage medium are provided, which relate to the technical fields of image processing, augmented reality, computer vision, deep learning and the like. The method includes: acquiring a three-dimensional face model of a to-be-processed face image, the three-dimensional face model comprising a plurality of grid nodes; determining a to-be-transformed area of the three-dimensional face model; acquiring a rigid transformation relationship between a standard three-dimensional face model and a standard stylized face model; and processing the to-be-transformed area based on the rigid transformation relationship, to obtain a stylized face model corresponding to the to-be-processed face image.

### CROSS-REFERENCE TO RELATED APPLICATION

This application claims priority to Chinese patent application No. 202110796598.X, filed on Jul. 14, 2021, which is hereby incorporated by reference in its entirety.

### TECHNICAL FIELD

The present disclosure relates to the field of computer technology, and in particular to the fields of image processing, augmented reality, computer vision, deep learning and the like.

### BACKGROUND

With the gradual digitization and virtualization of people's life contents, and the popularization of concepts such as the digital world and digital twin, the application demands of virtual reality and augmented reality are bound to explode. As an important proxy form of people in the digital world, the personalized production of avatars still mainly depends on the customization of designers, and the cost is relatively high. Generally speaking, it costs tens of thousands to produce a low-quality proxy model. If a high-precision model is customized, for example, to create a digital host with a high similarity for a specific character, the cost is generally around one million.

In order to reduce the cost, the personalized avatar solution in the existing technology generally includes two processes of face reconstruction and reconstruction result stylization.

### SUMMARY

A face image processing method and apparatus, an electronic device, and a storage medium are provided by the present disclosure.

According to one aspect of the present disclosure, there is provided a face image processing method, which includes:

acquiring a three-dimensional face model of a to-be-processed face image, the three-dimensional face model including a plurality of grid nodes;

determining a to-be-transformed area of the three-dimensional face model;

acquiring a rigid transformation relationship between a standard three-dimensional face model and a standard stylized face model; and

processing the to-be-transformed area based on the rigid transformation relationship, to obtain a stylized face model corresponding to the to-be-processed face image.

According to another aspect of the present disclosure, there is provided an electronic device, which includes:

at least one processor; and

a memory communicatively connected with the at least one processor, wherein

the memory stores instructions executable by the at least one processor, and the instructions, when executed by the at least one processor, cause the at least one processor to perform the method in any one of embodiments of the present disclosure.

According to another aspect of the present disclosure, there is provided a non-transitory computer-readable storage medium storing computer instructions, wherein the computer instructions, when executed by a computer, cause the computer to perform the method in any one of the embodiments of the present disclosure.

It should be understood that the content described in this section is not intended to limit the key or important features of the embodiments of the present disclosure, nor is it intended to limit the scope of the present disclosure. Other features of the present disclosure will be easily understood through the following description.

### BRIEF DESCRIPTION OF THE DRAWINGS

The drawings are used to better understand the solution and do not constitute a limitation to the present disclosure, wherein:

FIG. 1 is a schematic diagram of a face image processing method in an embodiment of the present disclosure;

FIG. 2 is a schematic diagram of determining a to-be-transformed area of a three-dimensional face model in an embodiment of the present disclosure;

FIG. 3 is a schematic diagram of a face image processing method in an embodiment of the present disclosure;

FIG. 4 is a schematic diagram of a face image processing method in an embodiment of the present disclosure;

FIG. 5 is a schematic diagram of a face image processing method in an embodiment of the present disclosure;

FIG. 6 is a schematic diagram of a face image processing method in an embodiment of the present disclosure;

FIG. 7 is a schematic diagram of a face image processing apparatus in an embodiment of the present disclosure;

FIG. 8 is a schematic diagram of a relationship acquisition module in an embodiment of the present disclosure; and

FIG. 9 is a block diagram of an electronic device for implementing a face image processing method according to an embodiment of the present disclosure.

### DETAILED DESCRIPTION

Exemplary embodiments of the present disclosure are described below in combination with the drawings, including various details of the embodiments of the present disclosure to facilitate understanding, which should be considered as exemplary only. Thus, those of ordinary skill in the art should realize that various changes and modifications can be made to the embodiments described here without departing from the scope and spirit of the present disclosure. Likewise, descriptions of well-known functions and structures are omitted in the following description for clarity and conciseness.

In order to allow the generated personalized avatar to have both the face features in the original photo and the uniform stylized features of the avatar, and also in order to reduce the access cost of the new style avatar on the avatar automatic modeling system, the technical solution of the present disclosure provides a solution for generative stylized models that preserve the original face features.

It should be noted that the execution subject server of the face image processing method involved in various embodiments of the technical solution of the present disclosure may acquire face images in various public, legal and compliant ways, for example, which may be acquired from a public data set or acquired from a user with the authorization of the user.

The three-dimensional face model, the standard three-dimensional face model and the standard stylized face model involved in various embodiments of the technical solution of the present disclosure include the face information of the user indicated by the face image, but the constructions of the three-dimensional face model, the standard three-dimensional face model and the standard stylized face model are performed after authorization by the user, and the construction processes thereof are in compliance with relevant laws and regulations.

The executive subject of the present disclosure may be any electronic device, for example, a server or a terminal device. The following will describe the face image processing method in the embodiments of the present disclosure in detail.

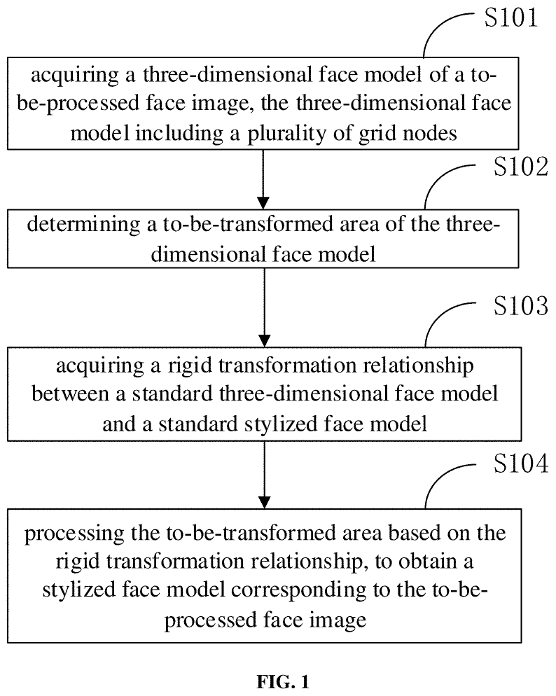

FIG. 1 shows a schematic diagram of a face image processing method in an embodiment of the present disclosure. As shown in FIG. 1, the face image processing method includes:

S101, acquiring a three-dimensional face model of a to-be-processed face image, the three-dimensional face model including a plurality of grid nodes;

In this embodiment, a server is used as the executive subject. After acquiring a two-dimensional to-be-processed face image, the server extracts the features of the to-be-processed face image, and reconstructs the two-dimensional face image according to the extracted features and the corresponding relationship between the two-dimensional image and the three-dimensional model, to obtain a three-dimensional face model. The three-dimensional face model includes a plurality of grid nodes, and the position of each grid node can be represented by a three-dimensional coordinate.

The specific ways for the server to acquire the two-dimensional to-be-processed face image may include, but are not limited to, acquiring in a preset image database, or receiving the face image sent by the user terminal, or acquiring the face image in other ways. This is not limited in the present disclosure.

S102, determining a to-be-transformed area of the three-dimensional face model;

herein, the to-be-transformed area may be an area in the three-dimensional face model that can reflect face features, it may be one area, or it may be two or more areas, and the specific location and number of the to-be-transformed area can be configured according to specific needs.

S103, acquiring a rigid transformation relationship between a standard three-dimensional face model and a standard stylized face model;

herein, the standard three-dimensional face model and the standard stylized face model are both pre-stored face models. The standard three-dimensional face model may be a standardized face model obtained according to the characteristics of a plurality of three-dimensional face models which are obtained by reconstructing a large number of face images. The standard stylized face model may be a face model designed according to different styles, for example, a style with big eyes and a small nose, a style with small eyes and a big nose, or the like. A plurality of standard stylized face models of different styles can be pre-stored.

The server calculates the rigid transformation relationship between each grid node in the standard three-dimensional face model to each grid node in the standard stylized face model. Rigid transformations include, but are not limited to, rotation, translation and scaling transformations.

S104, processing the to-be-transformed area based on the rigid transformation relationship, to obtain a stylized face model corresponding to the to-be-processed face image.

Optionally, areas, corresponding to the to-be-transformed area, in the standard three-dimensional face model and the standard stylized face model are determined, and the to-be-transformed area is processed based on the rigid transformation relationship between the corresponding area in the standard three-dimensional face model and the corresponding area in the standard stylized face model, to obtain a stylized face model.

For example, if the to-be-transformed area in the three-dimensional face model is an area where the left eye is located, the area where the left eye is located in the three-dimensional face model is processed based on the rigid transformation relationship between an area where the left eye is located in the standard three-dimensional face model and an area where the left eye is located in the standard stylized face model, to obtain the processed stylized face model. According to the face image processing method provided by the technical solution of the present disclosure, the to-be-transformed area of the to-be-processed face image is processed based on the rigid transformation relationship between the standard three-dimensional face model and the standard stylized face model, and the stylized face model obtained in this way greatly improves the similarity between the stylized face model and the to-be-processed face image on the premise of maintaining the overall style of the stylized face model. At the same time, based on the three-dimensional face model of the to-be-processed face image, the generation of the stylized face model can be automatically completed, thereby reducing the cost of material adaptation of multi-style avatars.

In the technical solution of the present disclosure, the specific method of acquiring the rigid transformation relationship between the standard three-dimensional face model and the standard stylized face model is shown in the following embodiments.

In an implementation, S103 includes:

S1031, dividing the standard three-dimensional face model and the standard stylized face model into a plurality of areas respectively in a same way, wherein each area includes a plurality of grid nodes; and

S1032, taking each area of the standard three-dimensional face model as a current area respectively, and determining a rigid transformation from the grid nodes of the current area to grid nodes of a corresponding area of the standard stylized face model, to obtain a rigid transformation matrix corresponding to the current area.

Specifically, the standard three-dimensional face model and the standard stylized face model are divided into a plurality of areas respectively, the numbers of areas in the two models are the same, and the location of each area in the standard three-dimensional face model corresponds to that of each of the standard stylized face model. For each current area in the standard three-dimensional face model, the rigid transformation from the grid nodes in the area to the grid nodes in the corresponding area of the standard stylized face model is calculated, to obtain a rigid transformation matrix. The rigid transformation relationship may be a rigid transformation matrix, and each element in the matrix is a rigid transformation from the grid nodes in each area of the standard three-dimensional face model to the grid nodes in a corresponding area of the standard stylized face model.

In the embodiment of the present disclosure, the standard three-dimensional face model and the standard stylized face model are divided into areas respectively in the same way, and the rigid transformation between the grid nodes in the corresponding areas in the standard three-dimensional face model and the standard stylized face model is calculated, to obtain a rigid transformation matrix. As the basis for subsequent processing of the to-be-processed face image, the rigid transformation can make the model transformation process retain more morphological features.

Herein, for how to divide the standard three-dimensional face model and the standard stylized face model into a plurality of areas respectively in the same way, refer to the following embodiments for details.

In an implementation, the dividing the standard three-dimensional face model and the standard stylized face model into the plurality of areas respectively in the same way, includes:

dividing the standard three-dimensional face model and the standard stylized face model into the plurality of areas based on positions of five sense organs of the standard three-dimensional face model and the standard stylized face model, respectively.

Specifically, the positions of the five sense organs in the standard three-dimensional face model and the standard stylized face model are determined respectively. When the standard three-dimensional face model and the standard stylized face model are divided into areas respectively, the five sense organs are the parts that can reflect the features of the face, thus the areas can be divided according to the positions of the five sense organs, so as to obtain the areas corresponding to the positions of the five sense organs in the standard three-dimensional face model and the areas corresponding to the positions of the five sense organs in the standard stylized face model.

In the embodiment of the present disclosure, the areas are divided according to the positions of the five sense organs in the standard three-dimensional face model and the standard stylized face model, and the rigid transformation of the grid nodes in each area of the standard three-dimensional face model and the standard stylized face model calculated in this way is applied to the to-be-processed face image, which can better reflect the features of the face in the to-be-processed face image.

In the technical solution of the present disclosure, the specific method of determining the to-be-transformed area of the three-dimensional face model is shown in the following embodiments.

In an implementation, S102 includes:

determining the to-be-transformed area of the three-dimensional face model, based on positions of five sense organs of the three-dimensional face model.

Specifically, when determining the to-be-transformed area of the three-dimensional face model, since the five sense organs are the parts that can reflect the features of the face, the to-be-transformed area can be determined according to the positions of the five sense organs. The areas corresponding to the positions of the five sense organs are taken as the to-be-transformed areas.

In the embodiment of the present disclosure, the to-be-transformed area of the three-dimensional face model is determined according to the positions of the five sense organs in the three-dimensional face model, such that the stylized face model is more similar to the face in the to-be-processed face image in the process of generating the stylized face model.

In an implementation, the positions of the five sense organs include at least one of: respective positions of a left eyebrow, a right eyebrow, a left eye, a right eye, a nose, a mouth, a cheek and a head cover.

Herein, the positions of the five sense organs may be a position corresponding to one of the left eyebrow, the right eyebrow, the left eye, the right eye, the nose, the mouth, the cheek and the head cover, or may be positions corresponding to more of them.

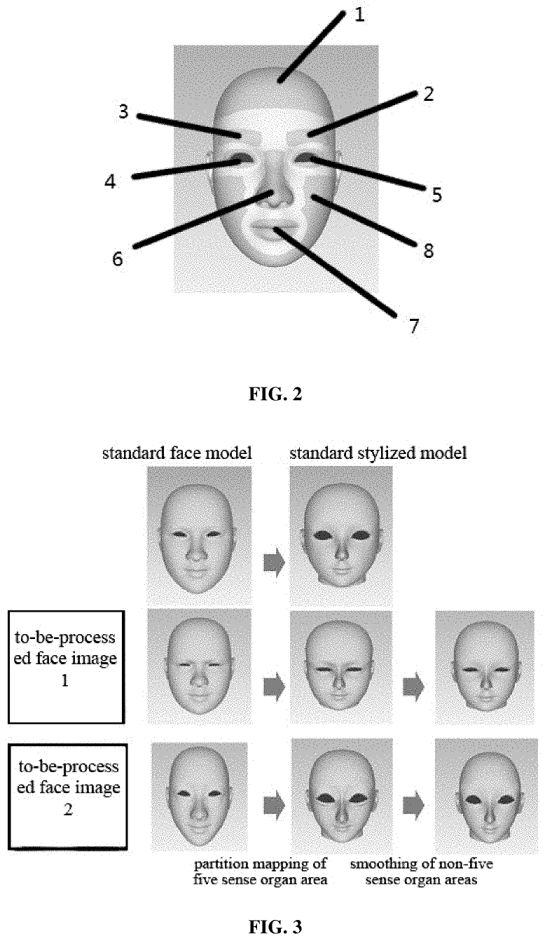

In a specific embodiment, the three-dimensional face model corresponding to the to-be-processed face image may be divided into 8 to-be-transformed areas according to the positions corresponding to the left eyebrow, the right eyebrow, the left eye, the right eye, the nose, the mouth, the cheek and the head cover, as shown in FIG. 2, the position corresponding to the head cover is area 1, the position corresponding to the right eyebrow is area 2, the position corresponding to the left eyebrow is area 3, the position corresponding to the left eye is area 4, the position corresponding to the right eye is area 5, the position corresponding to the nose is area 6, the position corresponding to the mouth is area 7, and the position corresponding to the cheek is area 8. When acquiring the rigid transformation relationship between the standard three-dimensional face model and the standard stylized face model, the rigid transformation matrices of the above 8 areas between the standard three-dimensional face model and the standard stylized face model are calculated to obtain 8 rigid transformation matrices, and the 8 to-be-transformed areas are processed respectively based on the 8 rigid transformation matrices, to obtain the stylized face model.

In the embodiment of the present disclosure, since the left eyebrow, the right eyebrow, the left eye, the right eye, the nose, the mouth, the cheek and the head cover in the face can reflect the features of the face, the to-be-transformed area of the three-dimensional face model is determined according to the positions of the left eyebrow, the right eyebrow, the left eye, the right eye, the nose, the mouth, the cheek and the head cover, such that the stylized face model is more similar to the face in the to-be-processed face image in the process of generating the stylized face model.

In the embodiment of the present disclosure, the specific implementation of processing the to-be-transformed area based on the rigid transformation relationship to obtain the stylized face model corresponding to the to-be-processed face image is shown in the following embodiments.

In an implementation, S104 includes:

S1041, transforming the to-be-transformed area based on the rigid transformation relationship; and

S1042, determining a boundary area between the to-be-transformed area and a non-to-be-transformed area of a transformed three-dimensional face model, and performing smoothing processing on the boundary area, to obtain the stylized face model corresponding to the to-be-processed face image.

In practical applications, after transforming the to-be-transformed area of the three-dimensional face model based on the rigid transformation relationship, the boundary area between the to-be-transformed area and the non-to-be-transformed area in the three-dimensional face model may appear an unsmooth phenomenon such as wrinkles. Therefore, the position of the boundary area needs to be determined, and the smoothing processing is performed on the grid nodes of the boundary area. In this way, the stylized face model corresponding to the to-be-processed face image is obtained through the rigid transformation and the smoothing processing.

In the embodiment of the present disclosure, through the rigid transformation and the smoothing processing, the stylized face model corresponding to the to-be-processed face image is obtained, which has a higher similarity with the face in the to-be-processed face image. Due to the smoothing processing, the visual effect is better.

In an implementation, the performing smoothing processing on the boundary area, to obtain the stylized face model corresponding to the to-be-processed face image, includes:

performing the smoothing processing on the boundary area by using a Laplace smoothing algorithm, to obtain the stylized face model corresponding to the to-be-processed face image.

Herein, the smoothing processing can be implemented by various smoothing processing algorithms, for example, the Laplace smoothing algorithm. It can be understood that other smoothing processing algorithms can also be used to process the boundary area with wrinkles, which is not limited in the present disclosure.

In the embodiment of the present disclosure, the Laplace smoothing algorithm is used to perform the smoothing processing on the boundary area, and the visual effect after processing is better, which can meet the needs of stylized model generation.

FIG. 3 is a schematic diagram of a face image processing method according to an embodiment of the present disclosure. In this embodiment, the face image processing method is implemented by a stylized model generation system. As shown in FIG. 3, a to-be-processed face image 1 is input into a stylized model generation system, to acquire a three-dimensional face model of the to-be-processed face image 1, such as an image in the second row and the second column in FIG. 3. The to-be-transformed area of the three-dimensional face model is determined based on the positions of the five sense organs in the three-dimensional face model, the rigid transformation relationship between the standard three-dimensional face model (such as the first image “standard face model” in the first row in FIG. 3) and the standard stylized face model (such as the second image “standard stylized model” in the first row in FIG. 3) are acquired, and the to-be-transformed area is transformed based on the rigid transformation relationship (such as “partition mapping of five sense organ areas” shown in FIG. 3), to obtain the transformed three-dimensional face model, such as an image in the second row and the third column in FIG. 3. The boundary area between the to-be-transformed area and the non-to-be-transformed area in the transformed three-dimensional face model is determined, and the smoothing processing is performed on the boundary area (such as “smoothing of non-five sense organ areas” shown in FIG. 3), to obtain a stylized face model corresponding to the to-be-processed face image 1, such as an image in the second row and the fourth column in FIG. 3. In the same way, a to-be-processed face image 2 is input into the stylized model generation system, to acquire the three-dimensional face model of the to-be-processed face image 2, such as an image in the third row and the second column in FIG. 3. The to-be-transformed area of the three-dimensional face model is determined based on the positions of the five sense organs of the three-dimensional face model, the rigid transformation relationship between the standard three-dimensional face model (such as the first image “standard face model” in the first row in FIG. 3) and the standard stylized face model (such as the second image “standard stylized model” in the first row in FIG. 3) are acquired, and the to-be-transformed area is transformed based on the rigid transformation relationship (such as “partition mapping of five sense organ areas” shown in FIG. 3), to obtain the transformed three-dimensional face model, such as an image in the third row and the third column in FIG. 3. The boundary area between the to-be-transformed area and the non-to-be-transformed area in the transformed three-dimensional face model is determined, and the smoothing processing is performed on the boundary area (such as “smoothing of non-five sense organ areas” shown in FIG. 3), to obtain a stylized face model corresponding to the to-be-processed face image 2, such as an image in the third row and the fourth column in FIG. 3.

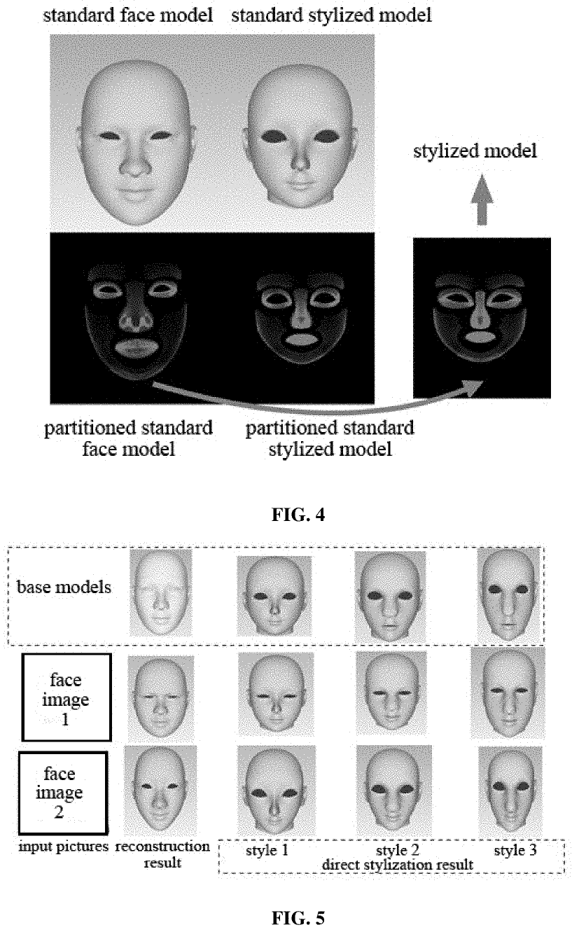

FIG. 4 is a schematic diagram of a face image processing method according to an embodiment of the disclosure. As shown in FIG. 4, a standard three-dimensional face model (such as the image “standard face model” in the first row and the first column in FIG. 4) and a standard stylized face model (such as the image “standard stylized model” in the first row and the second column in FIG. 4) are pre-stored, and the standard three-dimensional face model and the standard stylized face model are partitioned respectively according to the positions of the five sense organs, to obtain the partitioned standard three-dimensional face model (such as the image “partitioned standard face model” in the second row and the first column in FIG. 4) and the standard stylized face model (such as the image “partitioned standard stylized model” in the second row and the second column in FIG. 4). The standard three-dimensional face model and the standard stylized face model include a plurality of grid nodes respectively, and the rigid transformation relationship of the grid nodes in the corresponding areas of the standard three-dimensional face model and the standard stylized face model is calculated. Based on the rigid transformation relationship, the grid nodes in respective areas of the standard three-dimensional face model are processed, to obtain a processed stylized face model, such as the image “stylized model” in the second row and the third column in FIG. 4.

In the technical solution of the present disclosure, the standard stylized face model may be a plurality of pre-stored models. After the to-be-processed face image is processed based on the rigid transformation relationship obtained from the standard three-dimensional face model and the plurality of standard stylized face models, a plurality of stylized face models can be obtained. In this embodiment, the face image processing method is implemented by the stylized model generation system, including three standard stylized face models. FIG. 5 is a schematic diagram of a face image processing method according to an embodiment of the present disclosure. As shown in FIG. 5, the pre-stored models (such as the “base models” shown in the figure) include: a standard three-dimensional face model, a standard stylized face model of style 1, a standard stylized face model of style 2, and a standard stylized face model of style 3.

The to-be-processed face image (such as “face image 1” shown in FIG. 5) is input into the stylized model generation system, which reconstructs the to-be-processed face image, to obtain the reconstruction result, that is, the three-dimensional face model, such as the image in the second row and the second column shown in FIG. 5. The rigid transformation relationship between the standard three-dimensional face model (such as the first image in the first row in FIG. 5) and the standard stylized face model of style 1 (such as the second image in the first row in FIG. 5) is acquired. The three-dimensional face model is processed based on the rigid transformation relationship, and the smoothing processing is performed on the boundary area, to obtain the stylized face model of style 1 corresponding to the face image 1, such as the image in the second row and the third column in FIG. 5.

In the same way, the rigid transformation relationship between the standard three-dimensional face model (such as the first image in the first row in FIG. 5) and the standard stylized face model of style 2 (such as the third image in the first row in FIG. 5) is acquired. The three-dimensional face model is processed based on the rigid transformation relationship, and the smoothing processing is performed on the boundary area, to obtain the stylized face model of style 2 corresponding to the face image 1, such as the image in the second row and the fourth column in FIG. 5.

In the same way, the rigid transformation relationship between the standard three-dimensional face model (such as the first image in the first row in FIG. 5) and the standard stylized face model of style 3 (such as the fourth image in the first row in FIG. 5) is acquired. The three-dimensional face model is processed based on the rigid transformation relationship, and the smoothing processing is performed on the boundary area, to obtain the stylized face model of style 3 corresponding to the face image 1, such as the image in the second row and the fifth column in FIG. 5.

Using the same way for face image 2, the stylized face model of style 1 corresponding to the face image 2 (such as the image in the third row and the third column in FIG. 5), the stylized face model of style 2 (such as the image in the third row and the fourth column in FIG. 5), and the stylized face model of style 3 (such as the image in the third row and the fifth column in FIG. 5) are obtained.

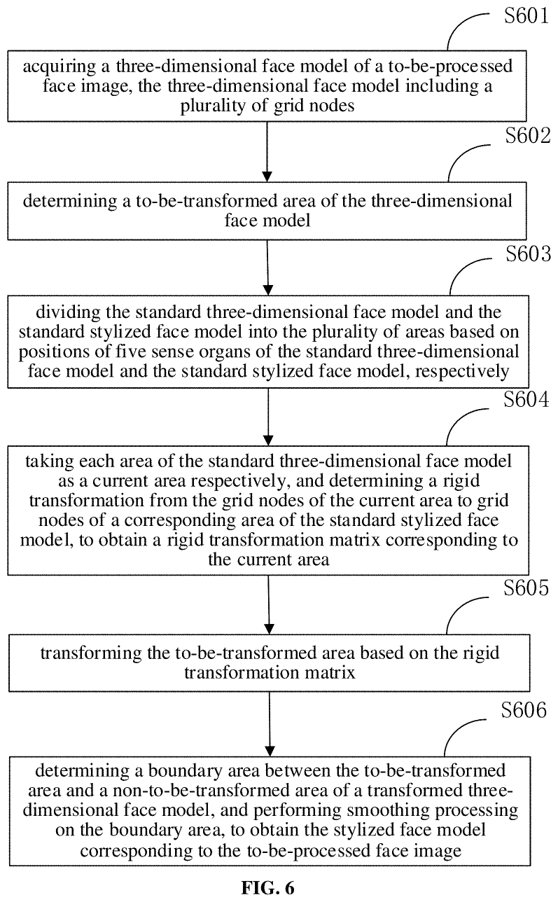

FIG. 6 is a schematic diagram of a face image processing method according to an embodiment of the disclosure. As shown in FIG. 6, the face image processing method may include:

S601, acquiring a three-dimensional face model of a to-be-processed face image, the three-dimensional face model including a plurality of grid nodes;

S602, determining a to-be-transformed area of the three-dimensional face model;

S603, dividing the standard three-dimensional face model and the standard stylized face model into the plurality of areas based on positions of five sense organs of the standard three-dimensional face model and the standard stylized face model, respectively;

S604, taking each area of the standard three-dimensional face model as a current area respectively, and determining a rigid transformation from the grid nodes of the current area to grid nodes of a corresponding area of the standard stylized face model, to obtain a rigid transformation matrix corresponding to the current area;

S605, transforming the to-be-transformed area based on the rigid transformation matrix; and

S606, determining a boundary area between the to-be-transformed area and a non-to-be-transformed area of a transformed three-dimensional face model, and performing smoothing processing on the boundary area, to obtain the stylized face model corresponding to the to-be-processed face image.

In the embodiment of the present disclosure, the to-be-transformed area of the three-dimensional face model is determined according to the positions of the five sense organs in the three-dimensional face model, such that the stylized face model is more similar to the face in the to-be-processed face image in the process of generating the stylized face model. Through the rigid transformation and the smoothing processing, the stylized face model corresponding to the to-be-processed face image is obtained, which has a higher similarity with the face in the to-be-processed face image. Due to the smoothing processing, the visual effect is better.

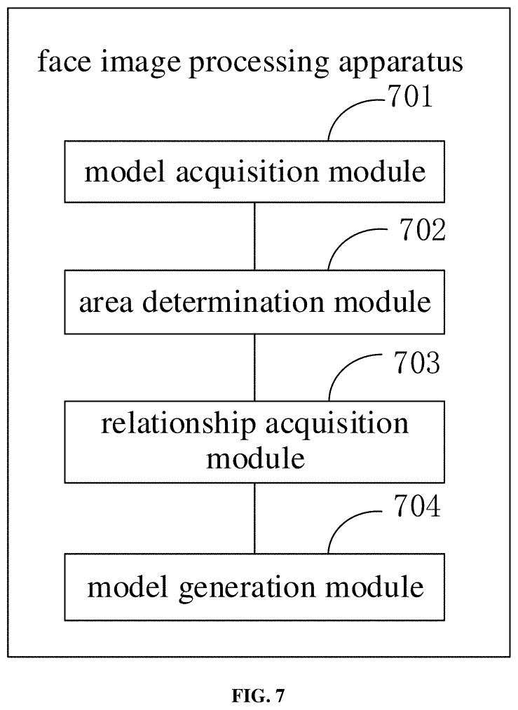

FIG. 7 is a schematic diagram of a face image processing apparatus according to an embodiment of the disclosure. As shown in FIG. 7, the face image processing apparatus may include:

a model acquisition module 701, configured for acquiring a three-dimensional face model of a to-be-processed face image, the three-dimensional face model including a plurality of grid nodes;

an area determination module 702, configured for determining a to-be-transformed area of the three-dimensional face model;

a relationship acquisition module 703, configured for acquiring a rigid transformation relationship between a standard three-dimensional face model and a standard stylized face model; and

a model generation module 704, configured for processing the to-be-transformed area based on the rigid transformation relationship, to obtain a stylized face model corresponding to the to-be-processed face image.

According to the face image processing apparatus provided by the technical solution of the present disclosure, the to-be-transformed area of the to-be-processed face image is processed based on the rigid transformation relationship between the standard three-dimensional face model and the standard stylized face model, and the stylized face model obtained in this way greatly improves the similarity between the stylized face model and the to-be-processed face image on the premise of maintaining the overall style of the stylized face model. At the same time, based on the three-dimensional face model of the to-be-processed face image, the generation of the stylized face model can be automatically completed, thereby reducing the cost of material adaptation of multi-style avatars.

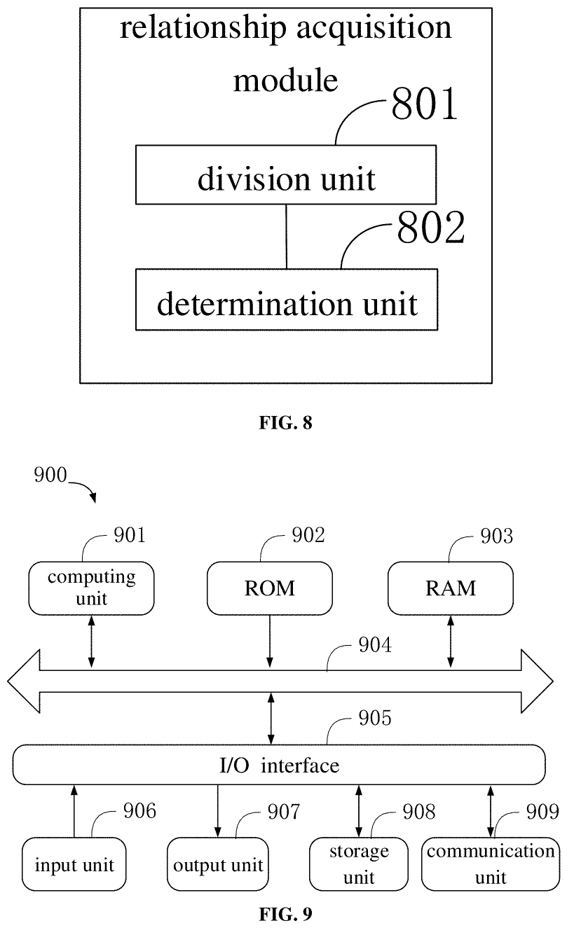

FIG. 8 is a schematic diagram of a relationship acquisition module in an embodiment of the present disclosure. As shown in FIG. 8, in an implementation, the relationship acquisition module 703 includes a division unit and a determination unit;

the division unit 801 is configured for dividing the standard three-dimensional face model and the standard stylized face model into a plurality of areas respectively in a same way, wherein area includes a plurality of grid nodes; and

the determination unit 802 is configured for taking each area of the standard three-dimensional face model as a current area respectively, and determining a rigid transformation from the grid nodes of the current area to grid nodes of a corresponding area of the standard stylized face model, to obtain a rigid transformation matrix corresponding to the current area.

In an implementation, the division unit 801 is further configured for:

dividing the standard three-dimensional face model and the standard stylized face model into the plurality of areas based on positions of five sense organs of the standard three-dimensional face model and the standard stylized face model, respectively.

In an implementation, the area determination module 702 is further configured for:

determining the to-be-transformed area of the three-dimensional face model, based on positions of five sense organs of the three-dimensional face model.

In an implementation, the positions of the five sense organs includes at least one of: respective positions of a left eyebrow, a right eyebrow, a left eye, a right eye, a nose, a mouth, a cheek and a head cover.

In an implementation, the model generation module 704 includes a transformation unit and a processing unit;

the transformation unit is configured for transforming the to-be-transformed area based on the rigid transformation relationship; and

the processing unit is configured for determining a boundary area between the to-be-transformed area and a non-to-be-transformed area of a transformed three-dimensional face model, and performing smoothing processing on the boundary area, to obtain the stylized face model corresponding to the to-be-processed face image.

In an implementation, the processing unit, when performing the smoothing processing on the boundary area, is configured for:

performing the smoothing processing on the boundary area by using a Laplace smoothing algorithm, to obtain the stylized face model corresponding to the to-be-processed face image.

For the functions of respective units, modules, or sub-modules in each device in the embodiment of the present disclosure, reference may be made to the corresponding description in the foregoing method embodiments, and details are not described herein again.

In the technical solution of the present disclosure, the acquisition, storage and application of the user's personal information involved are in compliance with the provisions of relevant laws and regulations, and do not violate public order and good customs.

According to embodiments of the present disclosure, the present disclosure also provides an electronic device, a readable storage medium, and a computer program product.

FIG. 9 shows a schematic block diagram of an example electronic device 900 that may be used to implement the embodiments of the present disclosure. The electronic device is intended to represent various forms of digital computers, such as laptop computers, desktop computers, workstations, personal digital assistants, servers, blade servers, mainframe computers, and other suitable computers. The electronic device may also represent various forms of mobile devices, such as a personal digital assistant, a cellular telephone, a smart phone, a wearable device, and other similar computing devices. The components shown herein, their connections and relationships, and their functions are by way of example only and are not intended to limit the implementations of the present disclosure described and/or claimed herein.

As shown in FIG. 9, the electronic device 900 includes a computing unit 901 that may perform various suitable actions and processes in accordance with computer programs stored in a read only memory (ROM) 902 or computer programs loaded from a storage unit 908 into a random access memory (RAM) 903. In the RAM 903, various programs and data required for the operation of the electronic device 900 may also be stored. The computing unit 901, the ROM 902 and the RAM 903 are connected to each other through a bus 904. An input/output (I/O) interface 905 is also connected to the bus 904.

A plurality of components in the electronic device 900 are connected to the I/O interface 905, including: an input unit 906, such as a keyboard, a mouse, etc.; an output unit 907, such as various types of displays, speakers, etc.; a storage unit 908, such as a magnetic disk, an optical disk, etc.; and a communication unit 909, such as a network card, a modem, a wireless communication transceiver, etc. The communication unit 909 allows the electronic device 900 to exchange information/data with other devices over a computer network, such as the Internet, and/or various telecommunications networks.

The computing unit 901 may be various general purpose and/or special purpose processing assemblies having processing and computing capabilities. Some examples of the computing unit 901 include, but are not limited to, a central processing unit (CPU), a graphics processing unit (GPU), various specialized artificial intelligence (AI) computing chips, various computing units running machine learning model algorithms, a digital signal processor (DSP), and any suitable processor, controller, microcontroller, etc. The computing unit 901 performs various methods and processes described above, such as the face image processing method. For example, in some embodiments, the face image processing method may be implemented as computer software programs that are physically contained in a machine-readable medium, such as the storage unit 908. In some embodiments, some or all of the computer programs may be loaded into and/or installed on the electronic device 900 via the ROM 902 and/or the communication unit 909. In a case where the computer programs are loaded into the RAM 903 and executed by the computing unit 901, one or more of steps of the face image processing method may be performed. Alternatively, in other embodiments, the computing unit 901 may be configured to perform the face image processing method in any other suitable manner (e.g., by means of a firmware).

Various embodiments of the systems and techniques described herein above may be implemented in a digital electronic circuit system, an integrated circuit system, a field programmable gate array (FPGA), an application specific integrated circuit (ASIC), an application specific standard product (ASSP), a system on a chip (SOC), a load programmable logic device (CPLD), a computer hardware, a firmware, a software, and/or a combination thereof. These various implementations may include an implementation in one or more computer programs, which can be executed and/or interpreted on a programmable system including at least one programmable processor; the programmable processor may be a dedicated or general-purpose programmable processor and capable of receiving and transmitting data and instructions from and to a storage system, at least one input device, and at least one output device.

The program codes for implementing the methods of the present disclosure may be written in any combination of one or more programming languages. These program codes may be provided to a processor or controller of a general purpose computer, a special purpose computer, or other programmable data processing apparatus such that the program codes, when executed by the processor or controller, enable the functions/operations specified in the flowchart and/or the block diagram to be performed. The program codes may be executed entirely on a machine, partly on a machine, partly on a machine as a stand-alone software package and partly on a remote machine, or entirely on a remote machine or server.

In the context of the present disclosure, the machine-readable medium may be a tangible medium that may contain or store programs for using by or in connection with an instruction execution system, apparatus or device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any suitable combination thereof. More specific examples of the machine-readable storage medium may include one or more wire-based electrical connection, a portable computer diskette, a hard disk, a random access memory (RAM), a read-only memory (ROM), an erasable programmable read-only memory (EPROM or Flash memory), an optical fiber, a portable compact disk read-only memory (CD-ROM), an optical storage device, a magnetic storage device, or any suitable combination thereof.

In order to provide an interaction with a user, the system and technology described here may be implemented on a computer having: a display device (e. g., a cathode ray tube (CRT) or a liquid crystal display (LCD) monitor) for displaying information to the user; and a keyboard and a pointing device (e. g., a mouse or a trackball), through which the user can provide an input to the computer. Other kinds of devices can also provide an interaction with the user. For example, a feedback provided to the user may be any form of sensory feedback (e.g., visual feedback, auditory feedback, or tactile feedback); and an input from the user may be received in any form, including an acoustic input, a voice input or a tactile input.

The systems and techniques described herein may be implemented in a computing system (e.g., as a data server) that may include a background component, or a computing system (e.g., an application server) that may include a middleware component, or a computing system (e.g., a user computer having a graphical user interface or a web browser through which a user may interact with embodiments of the systems and techniques described herein) that may include a front-end component, or a computing system that may include any combination of such background components, middleware components, or front-end components. The components of the system may be connected to each other through a digital data communication in any form or medium (e.g., a communication network). Examples of the communication network may include a local area network (LAN), a wide area network (WAN), and the Internet.

The computer system may include a client and a server. The client and the server are typically remote from each other and typically interact via the communication network. The relationship of the client and the server is generated by computer programs running on respective computers and having a client-server relationship with each other. The server can be a cloud server, a distributed system server, or a server combined with a blockchain.

It should be understood that the steps can be reordered, added or deleted using the various flows illustrated above. For example, the steps described in the present disclosure may be performed concurrently, sequentially or in a different order, so long as the desired results of the technical solutions disclosed in the present disclosure can be achieved, and there is no limitation herein.

The above-described specific embodiments do not limit the scope of the present disclosure. It will be apparent to those skilled in the art that various modifications, combinations, sub-combinations and substitutions are possible, depending on design requirements and other factors. Any modifications, equivalent substitutions, and improvements within the spirit and principles of the present disclosure are intended to be included within the scope of the present disclosure.

What is claimed is:

1. A face image processing method, comprising:
acquiring a three-dimensional face model of a to-be-processed face image, the three-dimensional face model comprising a plurality of grid nodes;
determining a to-be-transformed area of the three-dimensional face model;
acquiring a rigid transformation relationship between a standard three-dimensional face model and a standard stylized face model; and
processing the to-be-transformed area based on the rigid transformation relationship, to obtain a stylized face model corresponding to the to-be-processed face image.

2. The method of claim 1, wherein the acquiring the rigid transformation relationship between the standard three-dimensional face model and the standard stylized face model, comprises:
dividing the standard three-dimensional face model and the standard stylized face model into a plurality of areas respectively in a same way, wherein each area comprises a plurality of grid nodes; and
taking each area of the standard three-dimensional face model as a current area respectively, and determining a rigid transformation from the grid nodes of the current area to grid nodes of a corresponding area of the standard stylized face model, to obtain a rigid transformation matrix corresponding to the current area.

3. The method of claim 2, wherein the dividing the standard three-dimensional face model and the standard stylized face model into the plurality of areas respectively in the same way, comprises:
dividing the standard three-dimensional face model and the standard stylized face model into the plurality of areas based on positions of five sense organs of the standard three-dimensional face model and the standard stylized face model, respectively.

4. The method of claim 1, wherein the determining the to-be-transformed area of the three-dimensional face model, comprises:
determining the to-be-transformed area of the three-dimensional face model, based on positions of five sense organs of the three-dimensional face model.

5. The method of claim 3, wherein the positions of the five sense organs comprise at least one of: respective positions of a left eyebrow, a right eyebrow, a left eye, a right eye, a nose, a mouth, a cheek and a head cover.

6. The method of claim 1, wherein the processing the to-be-transformed area based on the rigid transformation relationship, to obtain the stylized face model corresponding to the to-be-processed face image, comprises:
transforming the to-be-transformed area based on the rigid transformation relationship; and
determining a boundary area between the to-be-transformed area and a non-to-be-transformed area of a transformed three-dimensional face model, and performing smoothing processing on the boundary area, to obtain the stylized face model corresponding to the to-be-processed face image.

7. The method of claim 6, wherein the performing the smoothing processing on the boundary area, to obtain the stylized face model corresponding to the to-be-processed face image, comprises:
performing the smoothing processing on the boundary area by using a Laplace smoothing algorithm, to obtain the stylized face model corresponding to the to-be-processed face image.

8. The method of claim 4, wherein the positions of the five sense organs comprise at least one of: respective positions of a left eyebrow, a right eyebrow, a left eye, a right eye, a nose, a mouth, a cheek and a head cover.

9. An electronic device, comprising:
at least one processor; and
a memory communicatively connected with the at least one processor, wherein
the memory stores instructions executable by the at least one processor, and the instructions, when executed by the at least one processor, cause the at least one processor to perform operations of:
acquiring a three-dimensional face model of a to-be-processed face image, the three-dimensional face model comprising a plurality of grid nodes;
determining a to-be-transformed area of the three-dimensional face model;
acquiring a rigid transformation relationship between a standard three-dimensional face model and a standard stylized face model; and
processing the to-be-transformed area based on the rigid transformation relationship, to obtain a stylized face model corresponding to the to-be-processed face image.

10. The electronic device of claim 9, wherein the instructions, when executed by the at least one processor, cause the at least one processor to further perform operations of:
dividing the standard three-dimensional face model and the standard stylized face model into a plurality of areas respectively in a same way, wherein each area comprises a plurality of grid nodes; and
taking each area of the standard three-dimensional face model as a current area respectively, and determining a rigid transformation from the grid nodes of the current area to grid nodes of a corresponding area of the standard stylized face model, to obtain a rigid transformation matrix corresponding to the current area.

11. The electronic device of claim 10, wherein the instructions, when executed by the at least one processor, cause the at least one processor to further perform an operation of:
dividing the standard three-dimensional face model and the standard stylized face model into the plurality of areas based on positions of five sense organs of the standard three-dimensional face model and the standard stylized face model, respectively.

12. The electronic device of claim 9, wherein the instructions, when executed by the at least one processor, cause the at least one processor to further perform an operation of:
determining the to-be-transformed area of the three-dimensional face model, based on positions of five sense organs of the three-dimensional face model.

13. The electronic device of claim 11, wherein the positions of the five sense organs comprise at least one of: respective positions of a left eyebrow, a right eyebrow, a left eye, a right eye, a nose, a mouth, a cheek and a head cover.

14. The electronic device of claim 12, wherein the positions of the five sense organs comprise at least one of: respective positions of a left eyebrow, a right eyebrow, a left eye, a right eye, a nose, a mouth, a cheek and a head cover.

15. The electronic device of claim 9, wherein the instructions, when executed by the at least one processor, cause the at least one processor to further perform operations of:
transforming the to-be-transformed area based on the rigid transformation relationship; and
determining a boundary area between the to-be-transformed area and a non-to-be-transformed area of a transformed three-dimensional face model, and performing smoothing processing on the boundary area, to obtain the stylized face model corresponding to the to-be-processed face image.

16. The electronic device of claim 15, wherein the instructions, when executed by the at least one processor, cause the at least one processor to further perform an operation of:
performing the smoothing processing on the boundary area by using a Laplace smoothing algorithm, to obtain the stylized face model corresponding to the to-be-processed face image.

17. A non-transitory computer-readable storage medium storing computer instructions, wherein the computer instructions, when executed by a computer, cause the computer to perform operations of:
acquiring a three-dimensional face model of a to-be-processed face image, the three-dimensional face model comprising a plurality of grid nodes;
determining a to-be-transformed area of the three-dimensional face model;
acquiring a rigid transformation relationship between a standard three-dimensional face model and a standard stylized face model; and
processing the to-be-transformed area based on the rigid transformation relationship, to obtain a stylized face model corresponding to the to-be-processed face image.

18. The non-transitory computer-readable storage medium of claim 17, wherein the computer instructions, when executed by the computer, cause the computer to further perform operations of:
dividing the standard three-dimensional face model and the standard stylized face model into a plurality of areas respectively in a same way, wherein each area comprises a plurality of grid nodes; and
taking each area of the standard three-dimensional face model as a current area respectively, and determining a rigid transformation from the grid nodes of the current area to grid nodes of a corresponding area of the standard stylized face model, to obtain a rigid transformation matrix corresponding to the current area.

19. The non-transitory computer-readable storage medium of claim 18, wherein the computer instructions, when executed by the computer, cause the computer to further perform an operation of:
dividing the standard three-dimensional face model and the standard stylized face model into the plurality of areas based on positions of five sense organs of the standard three-dimensional face model and the standard stylized face model, respectively.

20. The non-transitory computer-readable storage medium of claim 17, wherein the computer instructions, when executed by the computer, cause the computer to further perform an operation of:
determining the to-be-transformed area of the three-dimensional face model, based on positions of five sense organs of the three-dimensional face model.
